(19) United States
(12) Patent Application Publication
(10) Pub. No.: US 2026/0234483 A1
(43) Pub. Date: Aug. 13, 2026

(54) PROCESS OF TREATING CRUDE PYROLYSIS PRODUCT, TREATED PYROLYSIS PRODUCT AND APPLICATION THEREOF

(71) Applicant: BASF SE, Ludwigshafen am Rhein (DE)

(72) Inventors: Yan CHENG, Shanghai (CN); Pan LI, Shanghai (CN); Yuan ZOU, Shanghai (CN); Zu Ze MU, Binzhou (CN); Lucas DORAZIO, Iselin, NJ (US); Bradley Ronald MORRISON, Freeport, TX (US)

(21) Appl. No.: 19/152,963

(22) PCT Filed: Feb. 2, 2024
(86) PCT No.: PCT/CN2024/075539

§ 371 Date: Aug. 1, 2025

(30) Foreign Application Priority Data
Feb. 3, 2023 (CN) 202310094002.0

(51) Int. Cl. C10G 69/04

(52) U.S. Cl. CPC C10G 69/04; C10G 2300/1003; C10G 2300/4006; C10G 2300/4012; C10G 2300/4018; C10G 2300/70; C10G 2300/807

(57) ABSTRACT

The present disclosure relates to a process of treating a crude pyrolysis product, comprising: (1) providing the crude pyrolysis product; and (2) contacting the crude pyrolysis product with an upgrading catalyst at a temperature in the range of from 300° C. to 600° C., to obtain a refined pyrolysis product. The present disclosure further relates to the refined pyrolysis product and the use thereof as a raw material in a steam-cracking process.

### TECHNICAL FIELD

The present disclosure relates to chemical engineering field, in particular relates to a process of treating crude pyrolysis product, the treated pyrolysis product and the applications thereof.

### BACKGROUND

Technology for pyrolyzing and using waste plastics is a way to convert waste plastics into small molecules or oligomers via pyrolysis. With the development of the technology, a great deal of pyrolysis oils or pyrolysis waxes are produced.

Pyrolysis oils and pyrolysis waxes contain more aromatics, olefins, and higher hydrocarbons than naphtha. The relatively higher final boiling points of the pyrolysis products bring about challenges in follow-up processing. For example, pyrolysis oils and pyrolysis waxes are prone to coking during steam-cracking, which adversely influences the stability of the process. At the same time, sulfur-containing compounds, chlorine-containing compounds, nitrogen-containing compounds, gums, and other solid impurities are present in pyrolysis oils and pyrolysis waxes. The presence of these impurities downgrades the quality of the produced oils and causes issues such as deactivation of downstream catalyst(s) or corrosion of pipes, and adversely influences follow-up processing of the oils.

US publication US20210130262A1 discloses processes and systems for making hydrocarbons, which comprises catalytically cracking a feed stream comprising a pyrolysis oil via fluidized catalytic cracking (FCC) unit, fractionating FCC effluent stream to provide a FCC product stream comprising a recycle hydrocarbon (r-hydrocarbon), and finally cracking FCC product stream to form an olefin.

It is highly desirable to provide a catalytically cracking process that is suitable for pyrolysis oils and pyrolysis waxes of high final boiling point, which is capable for lowering the final boiling point and reducing the contents of impurities such as sulfur and nitrogen.

### SUMMARY OF THE INVENTION

According to an aspect of the disclosure, a process of treating a crude pyrolysis product is provided, which comprises:
(1) providing the crude pyrolysis product;
(2) contacting the crude pyrolysis product with an upgrading catalyst at a temperature in the range of from 300° C. to 600° C., to obtain a refined pyrolysis product.

According to another aspect of the disclosure, a refined pyrolysis product is provided, which is obtained by said process.

According to another aspect of the disclosure, the use of said refined pyrolysis product as a raw material in a steam-cracking process is provided.

The process of treating a crude pyrolysis product of the present disclosure has simple steps, and the product obtained therefrom has lowered final boiling point, at the same time the content of aromatics in the product is not obviously increased as compared with the starting materials and the contents of sulfur and nitrogen are decreased. The apparatus or system of the present disclosure for treating a crude pyrolysis product can be integrated into a waste-pyrolysis system.

### DESCRIPTION OF FIGURES

FIG. 1 depicts a chemical recycling system of some examples of the present disclosure;

FIG. 2 depicts a chemical recycling system of some other examples of the present disclosure;

FIG. 3 depicts a pyrolysis unit of some examples of the present disclosure;

FIG. 4 depicts a catalytic reactor of some examples of the present disclosure;

FIG. 5 depicts a process of treating a crude pyrolysis product of some examples of the present disclosure; and

FIG. 6 depicts a process of treating a crude pyrolysis product of some examples of the present disclosure.

### DETAILED DESCRIPTION

The present disclosure will be further illustrated in combination with specific embodiments. It should be understood that the embodiments are provided for interpreting the disclosure and are non-limiting.

Reference throughout this description of the disclosure to expressions such as “an example”, “some examples”, “exemplary embodiment”, “specific embodiment” or “some embodiments” means that a particular feature, structure, material, or characteristic described in connection with the embodiment or example is included in at least one embodiment or example of the present disclosure. Thus, the appearances of these expressions in various places throughout this disclosure are not necessarily referring to the same embodiment or example. Furthermore, the particular features, structures, materials, or characteristics that described may be combined in any suitable manner in one or more embodiments or examples. Also, in the circumstance that there is no contradiction, all the various embodiments or examples, as well as features and characteristics of all the various embodiments or examples disclosed herein, can be combined in all variations.

### Definitions

The words “include” or “comprise” as used in this disclosure are intended to be open-ended conjunctions, meaning to include listed elements but not necessarily to exclude other unlisted elements. The words “consisting essentially of . . . ” or “consisting substantially of . . . ” are intended to indicate the exclusion of other elements of any significance to the composition. The phrase “is composed of . . . ” or “consists of . . . ” is intended to be a conjunction, meaning the exclusion of all elements other than those listed, except for small amounts of impurities. The term “pyrolysis” means a chemical process, wherein chemical bonds of a solid mixture (such as a solid waste or a feed made therefrom) containing polymers are forced to break at high temperature to form smaller molecules (including but not limited to hydrocarbons of 1 to 60 carbon atoms, other non-hydrocarbon organics, inorganics such as hydrogen sulfide, nitrogen oxides, sulfur oxides, and the like). For example, low density polyethylene (LDPE) may be pyrolyzed into a mixture of a plurality of hydrocarbons at high temperature.

Pyrolysis product is a composition from pyrolysis. Pyrolysis product may be one or more of pyrolysis gas, pyrolysis oil and pyrolysis wax. Pyrolysis product may be gaseous phase, liquid phase, or solid phase at 25° C. and 1 atmospheric pressure. Crude pyrolysis product is a product obtained directly from pyrolysis or a product only being treated with operations such as condensing, fractionating, or filtrating after pyrolysis.

Pyrolysis gas is a composition that is a gas when measured at 25° C. and 1 atm, and which is derived at least in part from the pyrolysis of solid waste at a high temperature of, for example, 300° C. to 800° C.

Pyrolysis oil is a composition that is a liquid when measured at 25° C. and 1 atm, and which is derived at least in part from the pyrolysis of solid waste at a high temperature of, for example, 300° C. to 800° C.

Pyrolysis wax is a composition that is a solid when measured at 25° C. and 1 atm, and which is derived at least in part from the pyrolysis of solid waste at a high temperature of, for example, 300° C. to 800° C.

Pyrolysis gas, pyrolysis oil and/or pyrolysis wax typically contain hydrocarbons, such as saturated, unsaturated, aromatic, and alicyclic hydrocarbons with varying numbers of carbon atoms. There may also be other organics, water, gums, inorganic salts, or other impurities in pyrolysis oil and/or pyrolysis wax. Pyrolysis gas typically contains one or more of hydrogen, oxygen, nitrogen, nitrogen oxides, sulfur oxides, hydrogen sulfide, ammonia, hydrogen chloride, carbon monoxide, carbon dioxide, methane, ethane, ethylene, acetylene, propane, propylene, propyne, butane, isobutane, 1-butene, 2-butene, 2-methyl-propylene, 1-butyne, 2-butyne, and butadiene.

For the purposes of this disclosure, the liquid hourly space velocity of the crude pyrolysis oil passing through the upgrading catalyst is defined as the weight of the crude pyrolysis oil passing through a unit weight of the upgrading catalyst per hour.

### Catalytic Reactor

The process of treating a crude pyrolysis product according to the present disclosure can be performed in a catalytic reactor known to those skilled in the art.

The catalytic reactor may be packed with an upgrading catalyst for performing the chemical process of catalytically treating the crude pyrolysis product.

According to some embodiments of the present disclosure, the catalytic reactor may be a fixed bed reactor, a fluidized bed reactor, a moving bed reactor, a trickle bed reactor, or a boiling bed reactor. In some embodiments, a fixed bed reactor is used. Fixed bed reactor has a simple structure and allows for adjustable temperature profile and/or residence time. Also, the mechanical abrasion of the catalyst loaded in a fixed bed reactor is relatively low.

According to some embodiments of the present disclosure, the catalytic reactor may treat the crude pyrolysis product in a batch, semi-batch, or continuous manner. The catalytic reactor may be a batch reactor, a semi-batch reactor, a continuous reactor, or a plug flow reactor. In some embodiments, the catalytic reactor is a continuous reactor. Furthermore, in some embodiments, the catalytic reactor is a continuous tank reactor.

According to some embodiments of the present disclosure, the catalytic reactor may be an adiabatic reactor comprising a single-stage adiabatic reactor and a multi-stage adiabatic reactor, a non-adiabatic reactor, an isothermal reactor, a non-isothermal reactor, or any combination of two or more of them.

According to some embodiments of the present disclosure, the catalytic reactor may take different shapes or structures, such as, but not limited to, a kettle reactor, a tower reactor, a tubular reactor, a tube bundle reactor, a coil reactor, or a spiral reactor, etc.

### Upgrading Catalyst

According to some embodiments of the present disclosure, the upgrading catalyst is a solid acid catalyst, preferably a catalyst based on silica and/or alumina, more preferably an amorphous activated aluminosilicate, a molecular sieve, or a combination thereof, and further preferably a ZSM-5 molecular sieve, a Y-type molecular sieve, an amorphous activated aluminosilicate, or a combination thereof.

According to some embodiments of the present disclosure, the upgrading catalyst is preferably a combination of an amorphous activated aluminosilicate and a molecular sieve.

According to some embodiments of the present disclosure, the mass ratio of the amorphous activated aluminosilicate to the molecular sieve is preferably (0.01-100):1, more preferably (0.01-50):1, and further preferably (0.1-5):1.

According to some embodiments of the present disclosure, the form of the upgrading catalyst may be powder or microsphere. The upgrading catalyst may also be any extruded or other shaped body. The shape of the extruded or other shaped body includes, but is not limited to, spherical, ellipsoidal, annular, cylindrical, tubular, clover-shaped, honeycomb, gear-shaped, butterfly, or star-shaped, etc.

The upgrading catalyst may be prepared by extruding, pelletizing, ball-milling or dry-blending. In some embodiments, the upgrading catalyst is prepared by ball milling, extruding, and subsequently calcinating the components of the upgrading catalyst.

According to some embodiments of the present disclosure, the average pore size of the upgrading catalyst is preferably in the range of from 0.5 to 20 nm, more preferably 3 to 15 nm, further preferably 5 to 12 nm, and still further preferably 6 to 10 nm, as determined by nitrogen isothermal adsorption according to DIN 66134.

According to some embodiments of the present disclosure, the ratio of the external surface area to the internal surface area of the upgrading catalyst is preferably in the range of from 0.1 to 20, more preferably 0.5 to 10, and further preferably 0.8 to 5. The external surface area and the internal surface area is determined by nitrogen isothermal adsorption according to DIN 66134.

According to some embodiments of the present disclosure, the micropore area of the upgrading catalyst is preferably in the range of from 20 to 250 m²/g, more preferably 40 to 200 m²/g, and further preferably 60 to 180 m²/g, as determined by nitrogen isothermal adsorption according to DIN 66134.

The present disclosure is described below in connection with the accompanying figures.

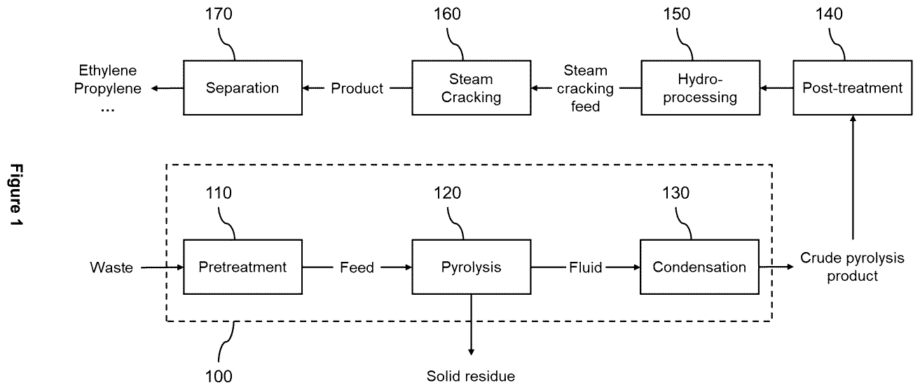

FIG. 1 illustrates a chemical recycling process according to some embodiments of the present disclosure.

A waste is processed into a feed suitable for a pyrolysis process via pretreatment unit 110. The feed is sent to pyrolysis unit 120 and converted into a hydrocarbon-containing fluid and solid residues at high temperature. At least a portion of the hydrocarbon-containing fluid is sent to condensation unit 130 and collected as a crude pyrolysis product. The crude pyrolysis product may include one or more of pyrolysis gas, pyrolysis oil, and pyrolysis wax.

The aforementioned pretreatment unit 110, pyrolysis unit 120 and condensation unit 130 may be integrated in chemical recycling system 100. Chemical recycling system 100 may be configured with devices such as a heat source, a power unit with corresponding pipes, valve(s) or pump(s), etc., to perform operations such as heating, cooling, conveying, transferring and/or controlling the flow direction/rate.

The crude pyrolysis product may be sent to post-treatment unit 140 where one or more operations comprising fractionation, rectification, removal of heteroatoms, filtration, ultrafiltration, extraction, flocculation, and adsorption, etc. are performed. The crude pyrolysis product may be treated by post-treatment unit 140 to obtain a refined pyrolysis product. The refined pyrolysis product contains less nitrogen-containing impurities, sulfur-containing impurities, chlorine-containing impurities, oxygen-containing impurities, ash, moisture, gums or asphaltenes, and is more suitable for hydroprocessing and subsequent steam-cracking.

After passing through post-treatment unit 140, at least a portion of the pyrolysis product may be sent to hydro-processing unit 150. Hydro-processing unit 150 may work under atmospheric or elevated pressure. Hydro-processing unit 150 is charged with a hydrogenation catalyst. The refined pyrolysis product is hydro-processed and may be converted into a steam-cracking feed which contains less olefins, alkynes, diolefins, aromatics, sulfur-containing substances, nitrogen-containing substances, and/or chlorine-containing substances and is more suitable for being sent to a steam-cracking process directly. In some embodiments, the hydro-processing unit 150 may crack organics in addition to hydrogenating the unsaturated organics in the refined pyrolysis product. Organics with more carbon atoms (e.g., 17, 18, 19, 20, or more carbon atoms) in the refined pyrolysis product may be cracked into organics with fewer carbon atoms (e.g., 10 or less carbon atoms). In some embodiments, hydro-processing unit 150 may also increase the hydrocarbon content of the refined pyrolysis product by removing nitrogen-containing compounds, sulfur-containing compounds, chlorine-containing compounds, or other impurities from the refined pyrolysis product through a hydrotreating process. In further some embodiments, hydro-processing unit 150 may also perform absorption, adsorption, or other separation operations on the product from hydrogenation to remove impurities such as hydrogen sulfide, ammonia, hydrogen chloride, or water.

The steam-cracking feed is sent to steam-cracking unit 160, where it undergoes a steam-cracking reaction with water vapor at high temperature. The steam-cracking reaction produces a variety of products such as ethylene, propylene, acetylene, butadiene, benzene, toluene, xylene, or cracked gasoline.

The products may be separated into chemical feedstocks such as ethylene, propylene, acetylene, and butadiene by separation unit 170. Ethylene, propylene, acetylene, and butadiene may subsequently be sent to industrial processes for the synthesis of polymers such as polyethylene, polypropylene, or polybutadiene, or may be used as starting materials for the synthesis of ethanol, ethylene oxide, propylene oxide, acrylonitrile, isopropanol, adipic acid, hexane diamine or other chemicals.

It may be understood that, in addition to the steam-cracking process, at least a portion of the crude pyrolysis product may be fed directly or after passing through the post-treatment unit 140 and/or hydro-processing unit 150 into other chemical processes for the production of fuels or chemical feedstocks, such as catalytic reforming, catalytic cracking, catalytic hydrogenating, solvent refining, delayed coking, oxidative cracking, or chemical processes for the preparation of syngas.

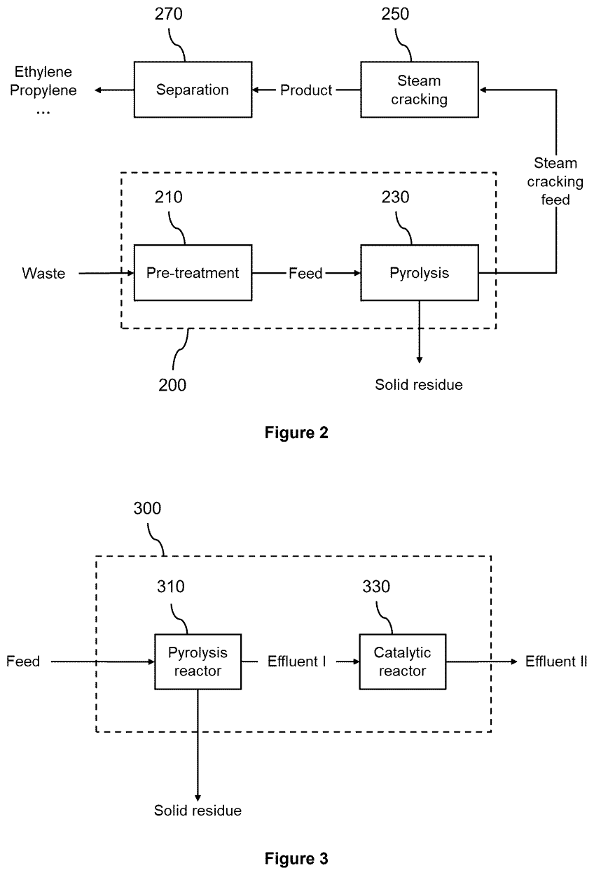

FIG. 2 illustrates a chemical recycling process according to some other embodiments of the present disclosure.

A waste is processed into a feed suitable for a pyrolysis process via pre-treatment unit 210. The feed is sent to pyrolysis unit 230 and converted into a hydrocarbon-containing steam-cracking feed and solid residues at high temperature. The steam-cracking feed may contain a variety of saturated, unsaturated, aromatic, and alicyclic hydrocarbons of varying molecular weights and boiling points, and other gases.

The aforementioned pre-treatment unit 210 and pyrolysis unit 230 may be integrated in a chemical recycling system 200. Chemical recycling system 200 may be configured with devices such as a heat source, a power unit with corresponding pipes, valve(s) or pump(s), etc., to perform operations such as heating, cooling, conveying, transferring and/or controlling the flow direction/rate. Chemical recycling system 200 may output a steam-cracking feed, which may be sent directly to a steam-cracking process.

The steam-cracking feed is sent to steam-cracking unit 250 and converted into products. The products may contain species such as hydrogen, methane, ethane, ethylene, acetylene, propane, propylene, propyne, butane, isobutane, 1-butene, 2-butene, 2-methyl-propylene, 1-butyne, 2-butyne, butadiene, benzene, toluene, or xylene.

The products may be separated into chemical feedstocks such as ethylene, propylene, acetylene, butadiene, benzene, toluene, and xylene by separation unit 270. Ethylene, propylene, acetylene, and butadiene may subsequently be sent to industrial processes for the synthesis of polymers such as polyethylene, polypropylene, or polybutadiene, or may be used as starting materials for the synthesis of ethanol, ethylene oxide, propylene oxide, acrylonitrile, isopropanol, adipic acid, hexane diamine or other chemicals.

FIG. 3 illustrates pyrolysis unit 300 in accordance with some embodiments of the present disclosure.

The pyrolysis unit 300 is used in a process of converting a solid waste containing waste plastics therein into a solid residue and an effluent containing pyrolysis products. Pyrolysis unit 300 may be used in chemical recycling system 100 shown in FIG. 1 or in chemical recycling system 200 shown in FIG. 2.

The pyrolysis unit 300 comprises pyrolysis reactor 310 and catalytic reactor 330. Catalytic reactor 330 is in fluid connection with pyrolysis reactor 310. The fluid connection may be a direct connection, such as connection via a pipe; or the fluid connection may be indirect, i.e., connection via pump(s), valve(s), or an intermediate device. The fluid connection may be interrupted or discontinued.

The solid waste enters pyrolysis reactor 310, where pyrolysis occurs under a high temperature condition. This high temperature condition may be accompanied with an almost oxygen-free atmosphere. Pyrolysis reactor 310 may have a single-stage, two-stage, or more-stage structure.

The solid waste may be converted into a solid residue and effluent I in pyrolysis reactor 310. Effluent I may contain a crude pyrolysis product. Effluent I may contain hydrocarbons, organic matters containing heteroatoms, and/or other gaseous/liquid components such as water (water vapor), carbon monoxide, carbon dioxide, hydrogen, or nitrogen. Effluent I may be a gas phase effluent and/or a liquid phase effluent.

At least a portion of effluent I may enter catalytic reactor 330 via a fluid connection. Catalytic reactor 330 may be provided with a catalyst. At least a portion of effluent I entering catalytic reactor 330 may undergo one or more reactions such as reforming, rearranging, disproportionating or cracking to produce effluent II at high temperature in the presence of a catalyst. Effluent II may contain hydrocarbons. Effluent II may contain less sulfur-containing components, nitrogen-containing components, chlorine-containing components, unsaturated hydrocarbons and/or aromatics in its chemical composition. Effluent II may be more suitable for chemical processes such as steam-cracking.

Effluent II may enter other devices or processes via fluid connections. In some embodiments, effluent II may enter a condenser after leaving catalytic reactor 330 and be collected. Alternatively, in some embodiments, effluent II may enter a steam-cracking device for subsequent reactions.

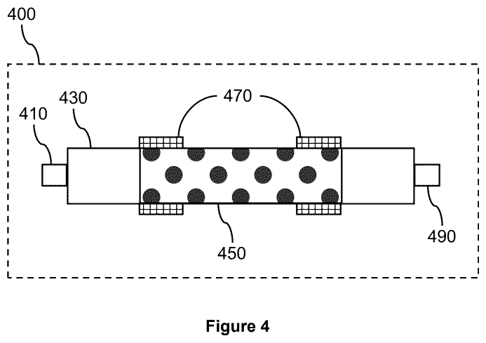

FIG. 4 illustrates catalytic reactor 400 in accordance with some embodiments of the present disclosure.

Catalytic reactor 400 is a tubular reactor comprising reactor inlet 410, tubular reactor body 430, heater 470 wrapped around the outer circumference of reactor body 430 and reactor outlet 490. Reactor body 430 is packed with upgrading catalyst 450. Under working condition, a constant temperature or an approximately constant temperature is maintained inside the reactor body 430. Catalytic reactor 400 can work continuously or in batches.

Reactor inlet 410 may be connected to a pyrolysis reactor or to a pyrolysis product (such as pyrolysis gas, pyrolysis oil and/or pyrolysis wax) storage tank, either directly or via device(s) such as pump(s) or valve(s). For example, reactor inlet 410 may receive a pyrolysis reactor effluent in the form of a crude pyrolysis product such as pyrolysis gas, pyrolysis oil, and/or pyrolysis wax. The crude pyrolysis product may enter reactor body 430 in a fluid form, such as a liquid or gaseous form, via reactor inlet 410.

Within reactor body 430, the crude pyrolysis product contacts with upgrading catalyst 450 and undergoes a catalytic reaction. The contact may occur at a temperature in the range of from 300° C. to 600° C.

Heater 470 may be a heating device known to a skilled person such as a heating tube or an electric heater. When working, heater 470 heats reactor body 430 and maintains it at a constant or approximately constant temperature.

After contacting with upgrading catalyst 450, an effluent is obtained as a refined pyrolysis product, which may leave catalytic reactor 400 via reactor outlet 490. The effluent may be sent to a subsequent processing device or may be collected by a condensing device.

Catalytic reactor 330 in FIG. 3 may adopt the structure of catalytic reactor 400 in FIG. 4.

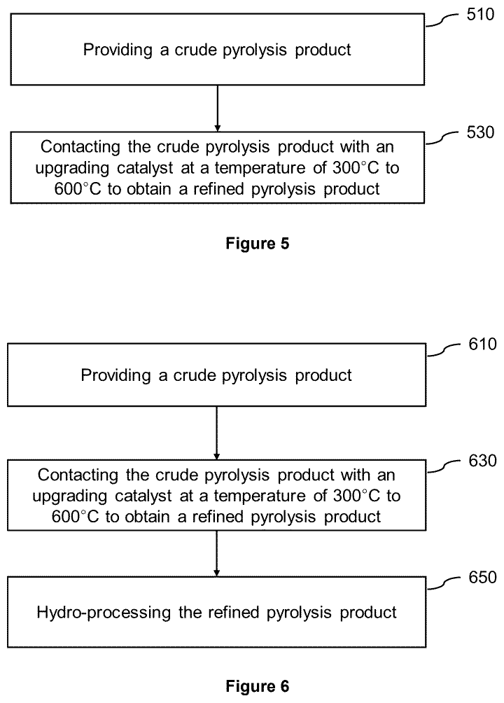

FIG. 5 illustrates a process of treating a crude pyrolysis product according to some embodiments of the present disclosure, comprising:

Step 510, providing a crude pyrolysis product;

Preferably, the crude pyrolysis product is obtained by pyrolysis of a solid waste containing waste plastics. In some embodiments, the waste plastics comprises polyethylene, polypropylene, ethylene-propylene copolymer, polybutylene, polybutadiene, or ethylene-propylene-diene rubber. In other embodiments, the waste plastics comprises polyethylene, polypropylene, ethylene-propylene copolymer and is obtained from sorting automotive shredder residue(s).

Step 530, contacting the crude pyrolysis product with an upgrading catalyst at a temperature of 300° C. to 600° C. to obtain a refined pyrolysis product.

The crude pyrolysis product may be present in gaseous or liquid form at the temperature of 300° C. to 600° C. as described above. The contact of the crude pyrolysis product with the upgrading catalyst may be a contact between the crude pyrolysis product and the upgrading catalyst occurring on the external surface or internal surface of the upgrading catalyst.

Step 530 is preferably carried out at a temperature of 320° C. to 500° C., and further preferably at a temperature of 350° C. to 450° C.

Step 530 is preferably carried out in an atmosphere at a pressure of 0.1 to 5 atm, further preferably at a pressure of 0.5 to 1.5 atm.

Preferably, step 530 further comprises passing the crude pyrolysis product through a reactor loaded with an upgrading catalyst. Further preferably, the crude pyrolysis product is passed through the upgrading catalyst at a liquid hourly space velocity of 0.01 h⁻¹ to 10 h⁻¹.

FIG. 6 illustrates a process of treating a crude pyrolysis product according to some other embodiments of the present disclosure, comprising:

Step 610, providing a crude pyrolysis product;

Step 630, contacting the crude pyrolysis product with an upgrading catalyst at a temperature of 300° C. to 600° C. to obtain a refined pyrolysis product; and

Step 650, hydro-processing the refined pyrolysis product.

Hydro-processing the refined pyrolysis product in step 650 may be carried out by contacting the refined pyrolysis product with a hydrogen source in the presence of a hydro-processing catalyst.

The addition reaction of unsaturated bonds may occur. Step 650 may provide a product with reduced amount of unsaturated hydrocarbon. Also, hydro-processing may reduce the contents of sulfur-containing substances, nitrogen-containing substances, and/or chlorine-containing substances. These effects are important for reducing coking or side reactions during the steam-cracking process.

The hydrogen source is a specie that can provide or produce hydrogen in the presence of a hydro-processing catalyst. Exemplary hydrogen sources include hydrogen gas.

The hydro-processing catalyst may comprise homogeneous catalysts and non-homogeneous catalysts, further comprise those catalysts known to a skilled person, for example, transition metals such as Raney nickel, Urushibara nickel, copper, cobalt, platinum, palladium or rhodium, transition metal compounds and alloys thereof.

Step 650 may provide a refined product with a high saturated hydrocarbon content, which can be used as a feedstock for chemical processes such as steam-cracking.

### Experiments

Crude pyrolysis oil: pyrolysis oil obtained by pyrolyzing an agricultural shed film (the main component of which was polyethylene) at a temperature in the range of from 300° C. to 400° C. using a homemade pyrolysis equipment. The pyrolysis oil was a light-yellow clear liquid with a density of 0.7-0.8 g/mL.

Crude pyrolysis wax: pyrolysis wax obtained by pyrolyzing the same feedstock at a temperature in the range of from 350° C. to 500° C. using the same equipment. The pyrolysis wax was a brown waxy solid under room temperature.

The boiling ranges and contents of impurities of the pyrolysis oil and the pyrolysis wax are given in Tables 1 and 2.

Upgrading catalyst: 11 catalyst samples were prepared by jet milling a molecular sieve and an amorphous silica-alumina (abbreviated as ASA), then blending with hydroxypropylmethylcellulose and boehmite, extruding, and calcinating, which were referred to as Cat 1 to Cat 11 in this disclosure, the data on the compositions and performances of which were listed in Table 3. Average pore size, micropore area, external surface area and internal surface area of the catalyst samples were determined by nitrogen isothermal adsorption according to DIN 66134.

Catalytic reactor: A thermostatic tubular reactor having a length of 70 cm, an external diameter of 40 mm and an internal diameter of 20 mm, wherein a temperature of 350° C. and a pressure of 1 atm were provided in the reactor. The catalytic reactor was heated by a heating jacket. The catalytic reactor was packed with a catalyst inside.

The liquid hourly space velocity of the crude pyrolysis oil and the crude pyrolysis wax passing through the upgrading catalyst is 1 h⁻¹. This liquid hourly space velocity is defined as the weight of the crude pyrolysis oil or the crude pyrolysis wax passing through a unit weight of the upgrading catalyst per hour. The treated product exited the catalytic reactor and were collected by condensation at 10° C.

TABLE 1
Analyses on boiling range and composition of crude pyrolysis oil
Boiling range

| | |
|---|---|
| 0%, ° C. | −1 |
| 5%, ° C. | 41.5 |
| 10%, ° C. | 69.5 |
| 20%, ° C. | 117.0 |
| 30%, ° C. | 157.0 |
| 40%, ° C. | 192.0 |
| 50%, ° C. | 232.0 |
| 60%, ° C. | 269.0 |
| 70%, ° C. | 322.5 |
| 80%, ° C. | 359.0 |
| 90%, ° C. | 400.0 |
| 95%, ° C. | 429.0 |
| 100%, ° C. | 485.0 |

Composition

| | |
|---|---|
| Aromatics content, wt. % | 8.99 |
| Nitrogen content, mg/kg | 125 |
| Sulfur content, mg/kg | 7.4 |

TABLE 2
Analyses on boiling range and composition of crude pyrolysis wax
Boiling range

| | |
|---|---|
| 0%, ° C. | 65.0 |
| 5%, ° C. | 144.5 |
| 10%, ° C. | 167.0 |
| 20%, ° C. | 219.5 |
| 30%, ° C. | 265.5 |
| 40%, ° C. | 317.5 |
| 50%, ° C. | 354.5 |
| 60%, ° C. | 391.5 |
| 70%, ° C. | 427.5 |
| 80%, ° C. | 466.0 |
| 90%, ° C. | 512.0 |
| 95%, ° C. | 545.0 |
| 100%, ° C. | 628.0 |

Composition

| | |
|---|---|
| Aromatics content, wt. % | 3.32 |
| Nitrogen content, mg/kg | 482 |
| Sulfur content, mg/kg | 33 |

TABLE 3
Analyses on composition and performance of catalysts

| Catalyst | Cat 1 | Cat 2 | Cat 3 | Cat 4 | Cat 5 | Cat 6 | Cat 7 | Cat 8 | Cat 9 | Cat 10 | Cat 11 |
|---|---|---|---|---|---|---|---|---|---|---|---|
| ASA:molecular sieve (w/w) | 0:1 | 1.86:1 | 1.35:1 | 1.35:1 | 4:1 | 0:1 | 1.22:1 | 1.11:1 | 1:1 | 1:1 | 1.43:1 |
| ASA:ZSM-5 (w/w) | 0:1 | 2.6:1 | 1.53:1 | 2.10:1 | 1:0 | 0:1 | 1:0 | 1:0 | 1:1 | 1:1 | 2:1 |
| Average pore size, nm | 5.42 | 7.5 | 7.59 | 7.59 | 7.07 | 5.02 | 7.79 | 7.80 | 8.65 | 8.18 | 7.57 |
| micropore area, m²/g | 157.4 | 78.6 | 76.8 | 86.5 | 66.6 | 43.7 | 136.5 | 103.2 | 68.1 | 67.4 | 61.6 |
| External surface area/ | 0.84 | 1.72 | 1.5 | 1.34 | 2.53 | 2.72 | 0.95 | 1.08 | 1.57 | 1.57 | 2.51 |
| internal surface area | | | | | | | | | | | |

ASA: amorphous silica-alumina
ZSM-5: ZSM-5 molecular sieve

TABLE 4
Properties of treated pyrolysis oils

| | Ex. 1 | Ex. 2 | Ex. 3 | Ex. 4 | Ex. 5 | Ex. 6 | Ex. 7 | Ex. 8 |
|---|---|---|---|---|---|---|---|---|
| Catalyst | Cat 1 | Cat 2 | Cat 3 | Cat 4 | Cat 5 | Cat 6 | Cat 7 | Cat 8 |
| Oil yield, wt % | 69.6 | 84.8 | 86.6 | 98.1 | 93.7 | 97.5 | 88.3 | 77.3 |
| Final boiling point, ° C. | 477.5 | 473.5 | 475.5 | 484.5 | 488.5 | 493.5 | 495 | 510 |
| Aromatics content, wt. % | 37.58 | 10.01 | 9.24 | 15.29 | 11.83 | 12.01 | 13.42 | 16.4 |
| Nitrogen content, mg/kg | 14 | 13 | 20 | NA | 7 | NA | 6 | NA |
| Sulfur content, mg/kg | 2.3 | 2.6 | 3.1 | NA | 1.9 | NA | 2.2 | NA |

NA: no data

TABLE 5
Analyses on boiling range of pyrolysis oils after cracking

| | Ex. 1 | Ex. 2 | Ex. 3 | Ex. 4 | Ex. 5 | Ex. 6 | Ex. 7 | Ex. 8 |
|---|---|---|---|---|---|---|---|---|
| 0%, ° C. | −36.5 | −1.5 | −7 | −1 | −20 | 5 | −16.5 | −15 |
| 5%, ° C. | 19 | 29 | 31 | 60.5 | 56.5 | 88.5 | 63.5 | 22 |
| 10%, ° C. | 34.5 | 66 | 66 | 95.5 | 94 | 122 | 97.5 | 41.5 |
| 20%, ° C. | 73.5 | 120 | 128.5 | 130.5 | 139 | 157 | 143 | 85.5 |
| 30%, ° C. | 113.5 | 159 | 166 | 162 | 161.5 | 186 | 167.5 | 123 |
| 40%, ° C. | 144 | 196 | 197.5 | 195.5 | 193 | 216 | 201.5 | 160 |
| 50%, ° C. | 153 | 230.5 | 235 | 225 | 255 | 246.5 | 233.5 | 201.5 |
| 60%, ° C. | 168.5 | 268.5 | 271 | 261 | 261.5 | 280 | 267 | 246.5 |
| 70%, ° C. | 211.5 | 319 | 317.5 | 301 | 310 | 325 | 315 | 291.5 |
| 80%, ° C. | 278 | 357 | 354.5 | 345.5 | 349 | 360.5 | 349.5 | 346 |
| 90%, ° C. | 360.5 | 397.5 | 393.5 | 386 | 391 | 397.5 | 391 | 390 |
| 95%, ° C. | 398.5 | 423 | 420 | 415 | 419.5 | 425 | 418.5 | 418.5 |
| 100%, ° C. | 477.5 | 473.5 | 475.5 | 484.5 | 488.5 | 493.5 | 495 | 510 |

TABLE 6
Properties of treated pyrolysis waxes

| | Ex. 9 | Ex. 10 | Ex. 11 | Ex. 12 | Ex. 13 | Ex. 14 | Ex. 15 | Ex. 16 | Ex. 17 |
|---|---|---|---|---|---|---|---|---|---|
| Catalyst | Cat 1 | Cat 2 | Cat 3 | Cat 4 | Cat 7 | Cat 8 | Cat 9 | Cat 10 | Cat 11 |
| Oil yield, wt % | 49.8 | 75.1 | 70.7 | 74.9 | 73.6 | 73.4 | 76.3 | 72.1 | 64.2 |
| Final boiling point, ° C. | 513 | 708.5 | 673 | 535 | 691.5 | 672 | 675 | 624.5 | 638.5 |
| Aromatics content, wt. % | 35.8 | 14.2 | 17.4 | 13.4 | 12.7 | 16.2 | 17.0 | 18.9 | 17.7 |
| Nitrogen content, mg/kg | 82 | 201 | 223 | 206 | 178 | 216 | 232 | 212 | 160 |
| Sulfur content, mg/kg | 25 | 24 | 23 | 21 | 18 | 22 | 24 | 26 | 21 |

TABLE 7
Analyses on boiling range of pyrolysis waxes after cracking

| | Ex. 9 | Ex. 10 | Ex. 11 | Ex. 12 | Ex. 13 | Ex. 14 | Ex. 15 | Ex. 16 | Ex. 17 |
|---|---|---|---|---|---|---|---|---|---|
| 0%, ° C. | 7 | −6 | −1.5 | −21.5 | −6 | 0 | 2 | −30 | −15.5 |
| 5%, ° C. | 44 | 37.5 | 28.5 | 19 | 82.5 | 29.5 | 30.5 | 21 | 25 |
| 10%, ° C. | 70 | 67.5 | 56.5 | 41.5 | 137.5 | 44.5 | 44.5 | 41.5 | 43 |
| 20%, ° C. | 99.5 | 124 | 104 | 85.5 | 185 | 95.5 | 90.5 | 75 | 81.5 |
| 30%, ° C. | 115 | 170.5 | 151.5 | 121.5 | 226.5 | 136 | 124.5 | 114.5 | 113.5 |
| 40%, ° C. | 142.5 | 218 | 196.5 | 151.5 | 267 | 172.5 | 167.5 | 151.5 | 146.5 |
| 50%, ° C. | 164.5 | 261.5 | 246 | 184 | 321.5 | 220 | 213 | 199 | 189 |
| 60%, ° C. | 209.5 | 323.5 | 292 | 219.5 | 359.5 | 268 | 267 | 250 | 245 |
| 70%, ° C. | 265.5 | 370 | 351 | 261.5 | 395.5 | 335 | 339 | 321.5 | 318.5 |
| 80%, ° C. | 337.5 | 418.5 | 397.5 | 327 | 440.5 | 388 | 396 | 375 | 377.5 |
| 90%, ° C. | 398 | 479.5 | 460 | 391.5 | 509 | 455 | 465 | 440 | 447.5 |
| 95%, ° C. | 437 | 537 | 515.5 | 440 | 593 | 511 | 521 | 487.5 | 500.5 |
| 100%, ° C. | 513 | 708.5 | 673 | 535 | 691.5 | 672 | 675 | 624.5 | 638.5 |

As shown in Table 4, after conducting catalytic reactions on the crude pyrolysis oil over catalysts Cat 1 to Cat 8 at 350° C. respectively, good yields were obtained, and nitrogen and sulfur contents were well controlled. It is worthwhile to point out that the refined pyrolysis oils treated in Experiments 2 and 3 both had lowered final boiling points and no significant increase in aromatic content compared to the crude pyrolysis oil. These performance indicators are favorable for subsequent steam-cracking.

Table 5 shows the boiling ranges of the pyrolysis oils after treatment in Experiments 1 to 8. Compared with the crude pyrolysis oil, the refined pyrolysis oils after the treatment in Experiments 1 to 5 all had an overall lowered boiling range.

The resultant mixture as treatment product of the pyrolysis waxes were oily liquid in room temperature. This phenomenon indicates a reduction of boiling range of the treatment product.

As shown in Table 6, the treated pyrolysis waxes all had their nitrogen and sulfur contents reduced in spite of increase of aromatics contents. In general, catalysts 1 through 4 and 7 through 11 had a good yield of oil.

Table 7 shows boiling ranges of the pyrolysis waxes after treatment in Experiments 9 to 17. Compared with the crude pyrolysis wax, the pyrolysis waxes after the treatment in Experiments 9 to 17 all have an overall lowered boiling range. In the original crude pyrolysis wax, the content of fraction having a boiling point under 210° C. was less than 20 wt. %. After being treated by the catalyst, the contents of fraction having a boiling point under 210° C. were all increased and higher than 20 wt. %. In Experiments 9, 12, 16, and 17, the contents of fraction having a boiling point under 210° C. even exceeded 50 wt. %. The treatment of crude pyrolysis wax by upgrading catalysts converted heavy hydrocarbons to lighter ones and simultaneously reduced the impurities levels in the collected fraction.

1.-15. (canceled)

16. A process of treating a crude pyrolysis product, comprising:
(1) providing the crude pyrolysis product; and
(2) contacting the crude pyrolysis product with an upgrading catalyst at a temperature in the range of from 300° C. to 600° C., to obtain a refined pyrolysis product.

17. The process of treating a crude pyrolysis product according to claim 16, wherein the upgrading catalyst is a solid acid catalyst.

18. The process of treating a crude pyrolysis product according to claim 17, wherein the upgrading catalyst is based on silica or alumina.

19. The process of treating a crude pyrolysis product according to claim 17, wherein the upgrading catalyst is a combination of an amorphous activated aluminosilicate with a molecular sieve.

20. The process of treating a crude pyrolysis product according to claim 19, wherein the mass ratio of the amorphous activated aluminosilicate to the molecular sieve is (0.01-100):1.

21. The process of treating a crude pyrolysis product according to claim 16, wherein the average pore size of the upgrading catalyst is in the range of from 0.5 to 20 nm, as determined by nitrogen isothermal adsorption according to DIN 66134.

22. The process of treating a crude pyrolysis product according to claim 16, wherein the ratio of the external surface area to the internal surface area of the upgrading catalyst is in the range of from 0.1 to 20, wherein the external surface area and the internal surface area is determined by nitrogen isothermal adsorption according to DIN 66134.

23. The process of treating a crude pyrolysis product according to claim 16, wherein the micropore area of the upgrading catalyst is in the range of from 20 to 250 m²/g, as determined by nitrogen isothermal adsorption according to DIN 66134.

24. The process of treating a crude pyrolysis product according to claim 16, wherein step (2) is carried out at a temperature of 320° C. to 500° C.

25. The process of treating a crude pyrolysis product according to claim 16, wherein step (2) is carried out in an atmosphere at a pressure of 0.1 to 5 atm.

26. The process of treating a crude pyrolysis product according to claim 16, wherein step (2) comprises:
(2a) passing the crude pyrolysis product through a reactor loaded with the upgrading catalyst.

27. The process of treating a crude pyrolysis product according to claim 26, wherein in step (2a), the crude pyrolysis product is passed through the upgrading catalyst at a liquid hourly space velocity of 0.01 h⁻¹ to 10 h⁻¹.

28. The process of treating a crude pyrolysis product according to claim 16, further comprising:
(3) hydroprocessing the refined pyrolysis product.

29. The process of treating a crude pyrolysis product according to claim 16, wherein the crude pyrolysis product is obtained by pyrolysis of a solid waste containing waste plastics.

30. The refined pyrolysis product obtained from the process of claim 16.

31. The use of the refined pyrolysis product of claim 30 as a raw material in a steam-cracking process.
